(19) United States
(12) Patent Application Publication
(10) Pub. No.: US 2022/0157192 A1
(43) Pub. Date: May 19, 2022

(54) Educational Article Folding Apparatus

(71) Applicant: Ebony Kay Martin, Frisco, TX (US)

(72) Inventor: Ebony Kay Martin, Frisco, TX (US)

(21) Appl. No.: 17/529,187

(22) Filed: Nov. 17, 2021

Related U.S. Application Data
(60) Provisional application No. 63/114,530, filed on Nov. 17, 2020.

(51) Int. Cl. G09B 19/00

(52) U.S. Cl. CPC G09B 19/003

(57) ABSTRACT

An educational article folding apparatus and particularly, one or more embodiments, that allows the user to be able to learn to perform the folding of an article properly with limited understanding of the material description. Specifically, the apparatus introduces the user to geometric terms; measuring; directional interaction; visual perception; hand eye coordination; chore teaching responsibility; life skills; and self-care. The apparatus is marked with a four-square ruler; directional arrows; instructional words; scored horizontal and vertical lines to direct the fold; and grid marks for correct article placement for the user to fold an article, by way of example, a face towel, successfully and properly.

### CROSS REFERENCE

This application claims the benefit of U.S. Provisional Patent Application No. 63/114,530, filed Nov. 17, 2020, which is incorporated by reference herein in its entirety.

### TECHNICAL FIELD

The present invention relates to an educational article folding apparatus.

### BACKGROUND

It's generally known that laundry folder boards exist. According to some occupational therapist, some children never learn to fold properly and those children that do get the opportunity to learn to fold a face towel, benefit by the child learning visual perception, hand eye coordination, chore teaching responsibility, life skills and self-care.

Presently, there is no educational towel folder board and solution designed to educationally teach the user how to fold articles properly, learn about geometric shapes, directions and measuring.

Some regular article folding boards are made of a rigid plastic and are heavy and bulky.

Many article folding boards are comprised of multiple boards connected with a type of hinge that fold independently of each other resulting in a folded item. Some of the hinges can be dangerous for the user's fingers.

### SUMMARY

The present invention seeks to provide a solution to the presented problems by providing an educational article folding apparatus that is a foldable one-piece board that is configured to match the unfolded size and shape of an article, by way of example, a face towel. An embodiment of the board includes a marked four-square ruler, directional arrows; instructional words; scored horizontal and vertical lines to direct the fold; perforated geometric objects, by way of example, squares and numbers, extracted from the board area; feet, by way of example, adhesive squares, on the back of the board as risers to easily grip the board; grid marks to aid in centering an article on the board; learning geometric terms; measuring; and visual perception and hand eye coordination to aid the user in learning how to fold the article properly.

### BRIEF DESCRIPTION OF DRAWINGS

To assist those of the skill in the art of making and using the disclosed embodiment and associated methods, reference is made to the accompanying figures, where in

The apparatus has one board 110, one four-square ruler 112, one scored, vertical fold line 114, one scored, horizontal fold line 116, four perforated geometric objects, by way of example, squares and numbers 118, four arrows on front of board 120, four arrows on back of board 122, instructional words on front of board 124, instructional words on the back of board and four feet, by way of example, adhesive squares, serving as risers on the back of board 126.

FIG. 1. Front of board 110

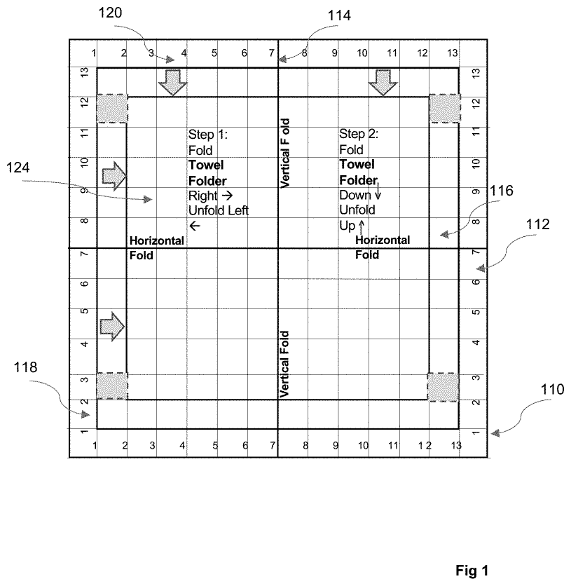

FIG. 2. Back of board 110

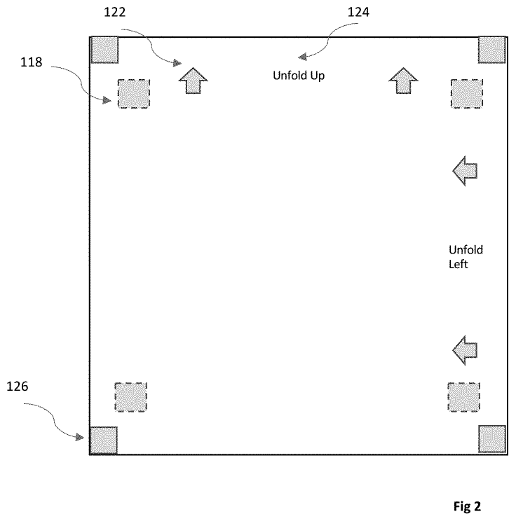

FIG. 3. Steps to fold an article

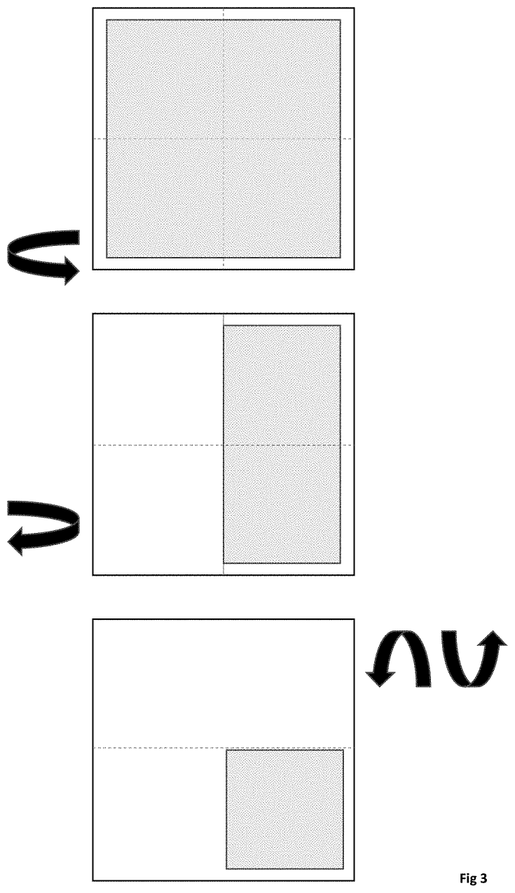

### BASIC DESCRIPTION OF HOW IT WORKS

The front of the board has marked vertical and horizontal scored fold lines to direct a user where to fold an article, by way of example, a face towel, that is placed on the board. When the user folds the board at the marked, vertical fold followed by unfolding the board and then folding the board at the horizontal fold and unfolding the board, the article remains property folded and compact in one quadrant of the board. The front of the board has markings with arrows and instructional words directing the user how to fold the article and has a four-square ruler and grid lines to measure and place the article in the center of the board to achieve the folded article.

Preferably, the board has a four-square ruler marked on the perimeter of the board which, when the user aligns the article in the center of the board, and the board is folded vertically and horizontally, the article will be properly folded into a smaller, compact article in one quadrant of the board.

Preferably, the board has one-inch grid lines marked on the board so that the user can place the article in the center of the board allowing the user to see the same number of squares around the article aiding in the article being centered on the board.

Preferably, the board has marked, perforated geometric objects on the board that can be removed by the user for extra engaging playtime and to help with the aerodynamics of the article not sliding off the board when the board is folded. Only the board is folded from one vertical and horizontal position to another leaving the article being manually manipulated on the board to a final fold in one quadrant of the board.

Preferably, the board has marked standard article size templates, by way of example, 10″×10″, 11″×11″, 12″×12″, to allow the user to place the article in the marked location on the board for accurate positioning to result in a properly folded article.

Preferably, the board has directional arrows and instructional word markings directing the user which way to fold the board to result in a properly folded article.

Preferably, the board has four feet, by way of example, adhesive squares, that mount and stick to the back of the board, in each quadrant of the board to raise the educational towel folder board slightly, by way of example, ⅛ of an inch, so the user can easily grasp the board to fold it vertically and horizontally to fold the article properly.

Preferably, the board, is made of a lightweight material, by way of example, a poster board or card stock. The board can be coated with, by way of example, lamination, for ease of cleaning and rigidness.

Preferably, board is made of one embodiment and does not comprise hinges to fold. The board will fold at the scored vertical and horizontal lines.

I claim:

1. An educational article folding apparatus, comprising:
a board having a front horizontally flat surface and a back horizontally flat surface serving as a template to fold an article when the article is placed on the front horizontally flat surface of the board;
a marked vertical scored fold line on the front horizontally flat surface of the board to facilitate folding of the board at the marked vertical scored fold line;
a marked horizontal scored fold line on the front horizontally flat surface of the board to facilitate folding of the board at the marked horizontal scored fold line;
a marked, four-square ruler on the perimeter of board;
a plurality of marked, directional arrows located on the front horizontally flat surface and the back horizontally flat surface of the board;
a plurality of marked, instructional words located on the front horizontally flat surface and the back horizontally flat surface of the board;
a plurality of marked grid lines located on the front horizontally flat surface of the board; a plurality of highlighted templates of one or more article sizes;
a plurality of marked, perforated geometric objects on the board that are removable to prevent movement of the article on the front horizontally flat surface of the board when the board is manipulated to a folded position; and
a plurality of feet on the back horizontally flat surface to facilitate spacing of the board when arranged on a surface.

2. A method of folding an article, the method comprising:
providing the educational article folding apparatus of claim 1;
removing the marked, perforated geometric objects from each quadrant of the board by manipulating the marked, perforated geometric objects out along the perforated edges;
folding the board at the scored vertical line, then unfold the board; and
folding the board at the scored horizontal line, then unfold the board.

3. The method of claim 2, further comprising:
finding, after folding the board at the scored horizontal line, then unfold the board, a plurality of locations on the board using one or more measuring scales located on each of the sides of the four-square ruler;
placing the article into a predefined work area on the front horizontally flat surface, the article having substantially the same area within the size of the work area;
folding the board at the vertical fold, then returning the board to an original state; and
folding the board at the horizontal fold, then returning the board to the original state, thereby resulting in the article being folded in a bottom right quadrant of the board.
